(19) United States
(12) Patent Application Publication
(10) Pub. No.: US 2026/0131663 A1
(43) Pub. Date: May 14, 2026

(54) Multi-Group Distributed Drive Vehicle Truck Braking System

(71) Applicant: Horizon Motor, Inc., Tucker, GA (US)

(72) Inventor: HONG-WEI JING, Duluth, GA (US)

(21) Appl. No.: 18/945,452

(22) Filed: Nov. 12, 2024

Related U.S. Application Data
(60) Provisional application No. 63/537,722, filed on Sep. 11, 2023.

(51) Int. Cl. B60L 7/26

(52) U.S. Cl. CPC B60L 7/26; B60L 2250/26; B60L 2260/24

(57) ABSTRACT

An electric tractor adapted to control a plurality of braking modes is provided. In one embodiment, a controller of the tractor is configured to control a braking system via a first mode, a second mode and a third mode, the first mode comprising providing at least one first mode output signal configured to control at least one electric brake of the electric trailer to provide feedback torque, the second mode comprising providing at least one second mode output signal configured to control at least one electric brake of the electric tractor and the at least one brake of the electric trailer to provide feedback torque, and the third mode comprising providing at least one third mode control signal configured to control at least one driving motor of the electric tractor and at least one driving motor of the electric trailer to provide feedback torque and to control an air brake of the electric tractor to engage.

### CROSS-REFERENCE TO RELATED APPLICATIONS

This application claims the benefit of U.S. provisional application No. 63/537,722, filed 11 Sep. 2023, which is hereby incorporated by reference as though fully set forth herein.

### BACKGROUND

### Field

The instant disclosure relates to a multi-group distributed drive vehicle train braking system.

### Background

A typical commercial vehicle train includes a tractor and a non-powered trailer. The vehicle wagon braking system is a trailer braking system including pneumatic brakes and electric brakes plus a traditional trailer air braking system.

A lack of coordination between the tractor and trailer braking systems can provide problems in comfort, increase the braking distance of the train, and lead to dangerous working conditions, such as trailer flicking.

Where the tractor and trailer have different effect times of an electric brake and air brake when the tractor has been working, for example, when the air brake of the trailer has not yet worked the difference may cause the trailer to hit the tractor. Since there is no communication connection between the tractor and the trailer, the electric brake of the tractor and the pneumatic brake of a trailer cannot coordinate.

### BRIEF SUMMARY

In one embodiment, a brake system for a multi-group distributed drive vehicle is provided. The brake system is adapted to coordinate between a tractor head brake and a power trailer brake and to coordinate the relationship between a power trailer electric brake and an air brake. The coordination is adapted to improve braking energy recovery of the trailer and to improve the economy and safety of the vehicle wagons.

Vehicle vans comprise a tractor and a trailer having a trailer drive system. Trailers may comprise conventional fuel vehicle, electric, or hybrid electric trailers. The tractor and trailer have a braking system communication system. The braking system communication system, in one embodiment, may be adaptive to the type of trailer.

The communication system is adapted to coordinate the regenerative braking performance of the powered trailer in order to improve braking function, such as by preventing the traction head from being hit and dragged, to improve comfort, decrease braking distance of the truck and provide safer working conditions (e.g., reduce or eliminate trailer rocking).

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 illustrates a schematic diagram of an example braking principal of a new energy commercial vehicle truck.

FIG. 2 illustrates a schematic diagram of an example braking principal of a multi-group new energy vehicle truck including a traction head driven by electricity, and a braking system including both pneumatic braking and electric braking.

FIG. 3 shows an example of a coast braking mode.

FIG. 4 shows an example of a light braking mode.

FIG. 5 shows an example of a moderate braking mode.

FIG. 6 shows an example of an emergency/full braking mode.

FIG. 7 illustrates a schematic diagram of an example braking principal of another multi-group new energy vehicle truck in which a traction head is driven by non-electric power, and the trailer is driven by electric power.

FIG. 8 illustrates a schematic diagram of a pressure module of a trailer brake system.

FIG. 9 illustrates a schematic diagram of a pressure control system including a pressure control module.

### DETAILED DESCRIPTION

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a” component can include two or more such components unless the context indicates otherwise. Also, the words “proximal” and “distal” are used to describe items or portions of items that are situated closer to and away from, respectively, a user or operator such as a surgeon. Thus, for example, the tip or free end of a device may be referred to as the distal end, whereas the generally opposing end or handle may be referred to as the proximal end.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The term “substantially” as used herein may be applied to modify any quantitative representation which could permissibly vary without resulting in a change in the basic function to which it is related.

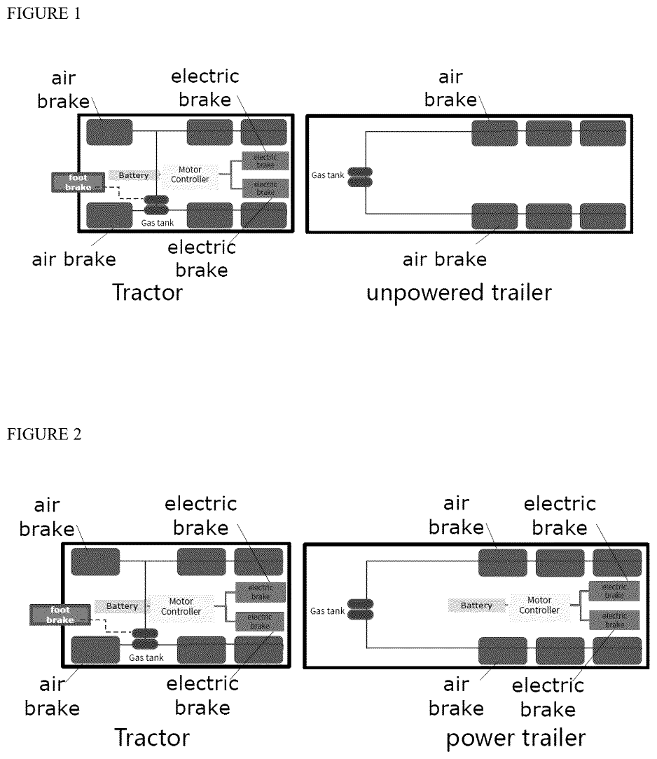

FIG. 1 illustrates a schematic diagram of an example braking principal of a new energy commercial vehicle truck with a traditional unpowered trailer. In this example, the braking system of a trailer is pneumatic braking and electric braking. The unpowered trailer includes a pneumatic braking system.

In this embodiment, both the tractor and the trailer have air brakes. Then the driver steps on the foot brake, the compressed air enters the air chamber of each tire brake from an air storage tank, and the whole vehicle starts to brake.

FIG. 2 illustrates a schematic diagram of an example braking principal of a multi-group new energy vehicle truck including an electrically driven traction head, and a braking system including both pneumatic braking and electric braking. The trailer, in this example, is powered by electricity, and the brake system also includes both pneumatic braking and electric braking.

In electric braking, the power of one or more battery supplies power to a drive motor through a motor controller to drive the vehicle forward. When the vehicle decelerates, the drive motor switches to a power generation/energy recovery mode through the motor controller. In the power generation/energy recovery mode, the motor generates feedback torque while generating power so that the vehicle can produce a braking effect.

In this example, a mode of braking includes the following:
Coast braking via electric braking of powered trailer(s).
Lightly step on the brake: the traction head and the power trailer are electrically braked.
Moderate braking: trailer electric braking, air braking, power trailer electric braking.
Emergency braking: traction head, power trailer air brake and electric brake work at the same time.

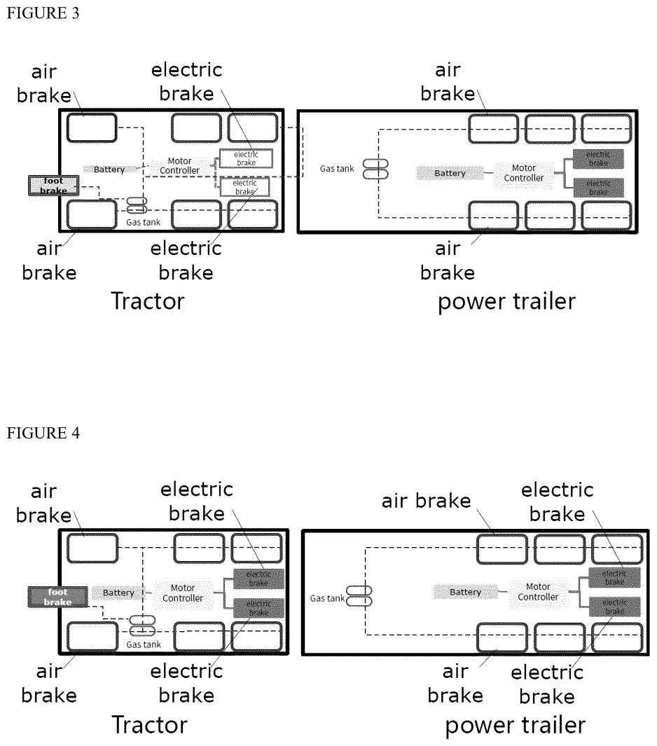

FIG. 3 shows an example of a coast braking mode. In this example, the coast mode is performed by a powered trailer electric brake. The driver of the truck does not need to step on the foot brake. The electric brakes coast by providing feedback torque in a power generation/energy recovery mode of the motor.

In one embodiment, for example, when the vehicle decelerates and the driver does not step on the brakes, the driving motor of the power trailer is switched to a power generation mode through the motor controller, and feedback torque is generated at the same time as power generation so that the vehicle has a braking effect. At this time, the motor of the tractor need not be working and/or providing drive power.

A tractor motor controller is adapted to determine whether a control signal indicates whether the foot brake has been activated. The power trailer motor controller is adapted to determine control signals related to one or more signals such as battery signals (e.g., a state of charge (SOC), voltage, current, etc.) and provide motor controller signals (e.g., torque, speed, etc.).

FIG. 4 shows an example of a light braking mode. In this example, electrical braking of a traction head and a powered trailer provide the truck braking. As a driver lightly steps on a foot brake, the electric brake of both the tractor and the powered trailer are engaged and provide feedback torque under control of a motor controller slowing the vehicle. The pneumatic system including the air storage tank are not utilized.

When the vehicle decelerates and the brakes are lightly applied, the drive motors of the traction head and the power trailer switch to a power generation mode through the motor controller, and generate feedback torque while generating power so that the vehicle can produce a braking effect.

In this embodiment, control signals may be determined by a tractor motor controller (e.g., a foot brake signal, a battery signal (SOC, voltage, current, etc.), and a motor control signal (e.g., torque, speed, etc.). Control signals for a power trailer motor controller may include one or more battery signals (e.g., SOC, voltage, current, etc.), motor controller signals (e.g., torque, speed, etc.), or the like.

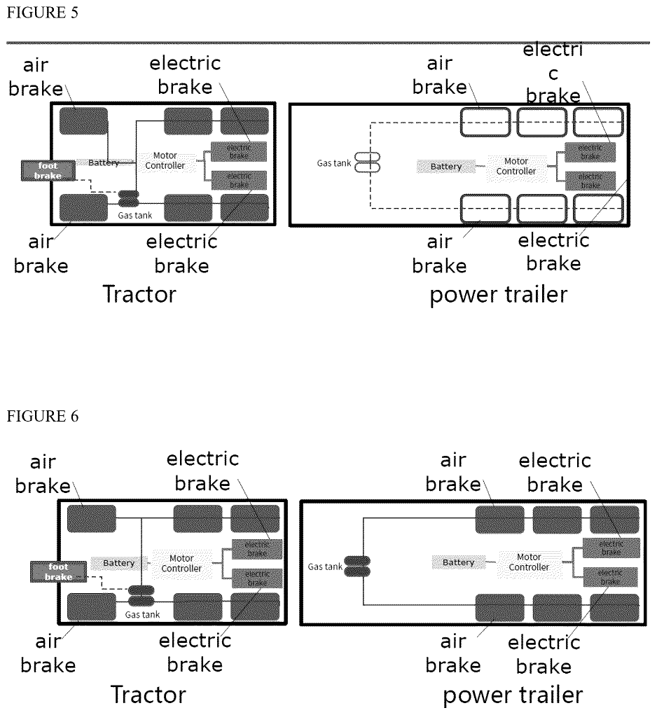

FIG. 5 shows an example of a moderate braking mode. In this example, the braking is performed by a combination of tractor electric braking, trailer air braking, and trailer electric braking. In this example, when the vehicle decelerates and the brake pedal stroke meets a predetermined threshold or is within a predetermined range (e.g., over 50 percent of the brake pedal stroke length), the driving motors of the traction head and power trailer switch to a power generation mode through a motor controller, and generate feedback torque at the same time as power generation so that the vehicle has a braking effect. At this time, the air brake of the traction head starts to engage/work and the compressed air enters the air brake chambers of the front and rear axles from the air storage tank.

Controller signals for the tractor may include one or more foot brake signals, battery signals (e.g., SOC, voltage, current, etc.), and/or motor controller signals (e.g., torque, speed, etc.). Controller signals for the power trailer may include one or more battery signals (e.g., SOC, voltage, current, etc.), and/or motor controller signals (e.g., torque, speed, etc.).

FIG. 6 shows an example of an emergency/full braking mode. In this example, the braking is performed by both the tractor head and the powered trailer engaging an air brake and an electric brake all at the same time.

In one embodiment, for example, when a vehicle decelerates and the stroke of the pedal meets a predetermined threshold or is within a predetermined range (e.g., over 90 percent or about 100 percent of the brake pedal stroke length), the driving motors of the traction head and power trailer switch to a power generation mode through the motor controllers, and generate feedback torque at the same time as the power generation so that the vehicle has a braking effect. At this time, the air brakes of the tractor head and the power trailer both engage/start to work as the compressed air in the air storage tank of the traction head enters the brake air chamber of the front and rear axles, and the compressed air of in the air storage tank of the power trailer enters the brake air chamber of the trailer axle.

Controller signals for the tractor may include one or more foot brake signals, battery signals (e.g., SOC, voltage, current, etc.), and/or motor controller signals (e.g., torque, speed, etc.). Controller signals for the power trailer may include one or more battery signals (e.g., SOC, voltage, current, etc.), and/or motor controller signals (e.g., torque, speed, etc.).

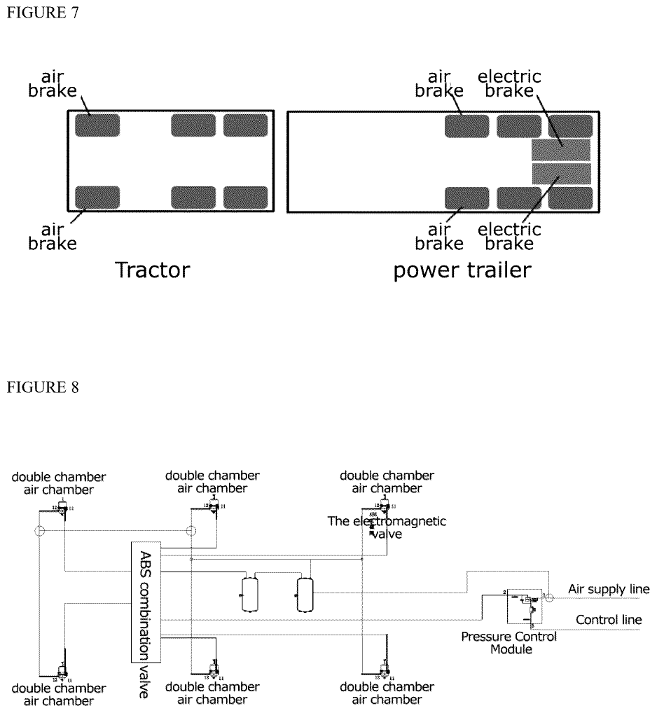

FIG. 7 illustrates a schematic diagram of an example braking principal of another multi-group new energy vehicle truck in which a traction head is driven by non-electric power, and the trailer is driven by electric power. In this example the trailer includes pneumatic braking, and the trailer braking system includes pneumatic braking and electric braking.

In this example, a mode of braking includes the following:
Coasting braking via electric braking of powered trailer(s).
Moderate braking: traction head air braking and power trailer electric braking.
Emergency braking: tractor air brake, power trailer air brake and electric brake work at the same time.

In the embodiments of FIGS. 2 and 7, for example, a trailer comprises an electric drive system. Trailer electric braking and air braking can be decoupled, and the electric braking can be provided as a primary braking system. The electric braking of the traction head (where present) and the power trailer can be decoupled, and an electric braking ratio of the traction head and the power trailer can be allocated according to one or more factors, such as road conditions. The braking system of the power trailer may adopt an adaptive control, and the power type of the tractor is not limited.

In these embodiments, the power trailer can adopt electric braking that provides reduced braking effect time and braking distance compared to pneumatic braking. Making use of the electric brake of the power trailer can further improve the economy of the truck operation. Truck braking can also reduce the frequency and intensity of air pressure braking and reduces the loss of friction plates. The trailer brake can also adjust the electric brake according to demand, which reduces the impact of the trailer on the tractor.

In one embodiment, a new type of automobile truck pipeline connection device (pressure control module device), referred to as “pressure control module”, which can effectively adjust the change of brake air pressure without affecting the traditional air brake, decoupled from the force rectangle of the braking energy feedback for more efficient use of energy feedback for braking, increasing the utilization rate of energy feedback to more than 90%.

FIG. 4 illustrates a schematic diagram of a pressure module of a trailer brake system.

FIG. 5 illustrates a schematic diagram of a pressure control system including a pressure control module.

In one embodiment, a pressure control module device is provided. The pressure control module device is arranged at an original position of a relay valve of the whole vehicle. The pressure control module comprises a control unit, a relay valve, a normally open two-position three-way valve, a two-position two-way valve, a throttle valve, a pressure sensor, and a pipeline.

A first port (port 1) of the pressure module is a gas supply line interface. A second port (port 2) is an output port of a control line. A third port (port 3) is an input port of the control line.

When the control unit does not participate in the work, the pressure control module is directly controlled by the 3-port control air pressure to perform the braking operation, which is consistent with the principle of the traditional air brake.

When the control unit participates in the work, the control unit closes the “normally open two-position three-way solenoid valve”, adjusts the two-position two-way solenoid valve, and then adjusts the air pressure at the output port of the 2-port control pipeline, and finally controls the power of the air pressure.

When the control unit is involved in the work, the braking force (electrical braking force) generated by the braking feedback is given priority to braking; when the electric braking force is less than the required total braking force, the control unit will synchronously control the size of the air pressure at the output port of the 2-port control pipeline, and then realize the total braking force to meet the demand.

When the control unit participates in the work, the control unit detects the total braking force demand value and the air braking force execution value output by the 2-port control pipeline according to the feedback signal of the pressure sensor.

When the control unit participates in the work, the control unit can also simultaneously collect the execution value of the electric braking force in real time.

In this embodiment, the control mode of a traditional vehicle air brake is retained. An air brake mode is also provided that can be electrified and controlled. The input demand can be quantified, and the output air pressure is fully controllable.

In this manner, the air brake can be controllable and can be effectively decoupled from the electric brake, improving the effect of braking energy feedback.

FIG. 8 illustrates an example schematic diagram of a pressure module of a trailer brake system. In this embodiment, the pressure module comprises a pressure control module that is coupled to an air supply line and a control line (e.g., a control line from a controller). The pressure control module is coupled to an anti-lock braking system (ABS) combination valve, and the air supply line is further coupled to a plurality of air chambers (e.g., double chamber air chambers as shown in FIG. 8). Each of the air chambers includes a valve (e.g., an electromagnetic valve). The valve may be operated under control of a controller, such as via the pressure control module, a vehicle or trailer controller, and/or the ABS combination valve.

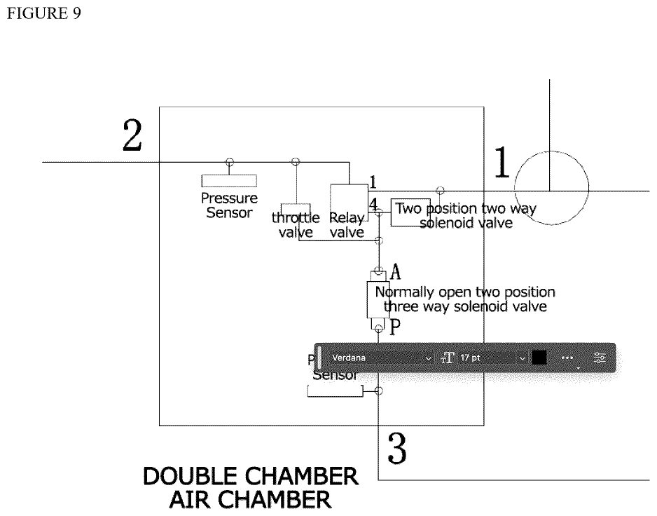

FIG. 9 illustrates a schematic diagram of one embodiment of a pressure control module such as shown in FIG. 8. In this embodiment, the pressure control module comprises inputs from the air supply line (1) and the control line (3). The pressure control module further comprises an output (2), such as shown coupled to the ABS combination valve as shown in FIG. 8.

As used herein, the term controller, motor controller, motor control unit or the like refer to a programmable controller programmed to control operation of one or more functions of an electric tractor and/or an electric trailer such as described herein. The controller includes at least a processor, memory or other data storage configured to store instructions to control the operation of the at least one processor, one or more inputs for receiving signals (e.g., feedback signals) from one or more sensors or devices of the electric tractor and/or electric trailer. The controller also includes one or more outputs for generating and providing one or more control signals to at least one controllable device of the electric tractor and/or electric trailer. Thus, the controller(s) are configured to receive one or more input signal (e.g., a feedback or other input signal such as but not limited to a brake pedal signal), process the received input signal(s) to generate an output control signal using the processor and instructions stored in the memory or other data storage, and to provide the output signal via the one or more outputs to one or more controllable devices of the electric tractor and/or electric trailer.

What is claimed is:

1. An electric tractor configured for use with an electric trailer, the electric tractor comprising:
a chassis comprising at least one electric drive axle, the at least one drive axle comprising at least one electric drive motor;
a motor controller coupled to the at least one electric drive motor of the electric drive axle, the motor controller comprising at least one input configured to receive an input signal, at least one processor, and at least one output, the processor programmed to generate at least one output signal based on the at least one input signal; and
a power storage device coupled to the at least one electric drive motor via the motor controller;
wherein the motor controller is configured to control a braking system via a first mode, a second mode and a third mode, the first mode comprising providing at least one first mode output signal configured to control at least one electric brake of the electric trailer to provide feedback torque, the second mode comprising providing at least one second mode output signal configured to control at least one electric brake of the electric tractor and the at least one brake of the electric trailer to provide feedback torque, and the third mode comprising providing at least one third mode control signal configured to control at least one driving motor of the electric tractor and at least one driving motor of the electric trailer to provide feedback torque and to control an air brake of the electric tractor to engage.

2. The electric tractor of claim 1, wherein the second mode is initiated based on an engagement of a brake control below a predetermined threshold level and the third mode is initiated based on engagement of the brake control at or above the predetermined threshold level.

3. The electric tractor of claim 2, wherein the brake control comprises a brake pedal.

4. The electric tractor of claim 1, wherein the first mode comprises a coast mode.

5. The electric tractor of claim 1, wherein the second mode comprises a light braking mode.

6. The electric tractor of claim 1, wherein the third mode comprises a moderate braking mode.

7. The electric tractor of claim 1, wherein the motor controller is configured to control the braking system via at least one fourth mode control signal configured to control at least one driving motor of the electric tractor and at least one driving motor of the electric trailer to provide feedback torque and to control an air brake of the electric tractor and an air brake of the electric trailer to engage.

8. The electric tractor of claim 7, wherein the fourth mode comprises an emergency braking mode.
